(19) United States
(12) Patent Application Publication
(10) Pub. No.: US 2022/0044001 A1
(43) Pub. Date: Feb. 10, 2022

(54) IMAGING SATELLITE

(71) Applicant: IGOR ABRAMOV, VISTA, CA (US)

(72) Inventor: IGOR ABRAMOV, VISTA, CA (US)

(21) Appl. No.: 17/493,396

(22) Filed: Oct. 4, 2021

Related U.S. Application Data
(63) Continuation-in-part of application No. 16/838,035, filed on Apr. 2, 2020.

(51) Int. Cl. G06K 9/00; G02B 5/10; B64G 1/10

(52) U.S. Cl. CPC G06K 9/0063; B64G 2001/1028; B64G 1/1021; G02B 5/10

(57) ABSTRACT

A satellite with a paraboloid mirror fabricated while in space is described. The mirror is formed by solidifying liquid precursor material after its surface assumes a paraboloid shape as a result of compound rotation of the satellite. The mirror is preferably formed from a photopolymer which creates a rigid paraboloid mirror surface upon exposure to a cross-linking radiation source. Optical coating(s) deposition system is described. Several deployable satellite structures, including mirror support are executed in shape memory materials and are deployed by application of heat.

### CROSS-REFERENCE TO RELATED APPLICATION

This is a continuation-in-part of application Ser. No. 16/838,035 filed on 2020 Apr. 2 titled “Imaging Satellite” which is incorporated herein in its entirety by reference and claims priority benefits thereof.

### FIELD OF INVENTION

This invention relates in general to space satellites and in particular to miniature- and ultra-miniature satellites with imaging capabilities.

### BACKGROUND OF INVENTION

At present, space satellites equipped with high resolution imaging systems are quite large in order to accommodate large optical structures required for high resolution imaging. A common satellite imaging system is a reflective-type telescope which contains a relatively large primary mirror.

This mirror is customarily made of a single piece of highly polished glass or other reflective materials such as beryllium or silicon carbide. The mirror has to be securely mechanically supported during launch to prevent its damage and potential damage to the satellite itself or the launch vehicle. The mirror support(s) introduce considerable added weight and bulk to the overall satellite imaging system, complicating its packaging for launch, increasing launch costs and limiting selection of launch vehicles.

Recent adoption and proliferation of miniature so called ‘cube’- and ‘nano’—satellites (‘cube-sats’) introduce a new paradigm to space exploration and utilization. However, the cube-sats at present lack high-resolution imaging capabilities, since they cannot accommodate large telescope primary mirrors required for such imaging.

Yet, such a capability would greatly enhance the utility of cube-sats and put their performance close to-, or even on-par with the large space telescopes currently deployed.

### OBJECTIVES OF THE INVENTION

Thus, it is the objective of instant invention to provide a high resolution imaging capability to miniature cube-sats.

Another objective is to provide a relatively large imaging mirror to a miniature cube-sat to enhance its imaging capability.

Yet another objective is to provide an imaging mirror which would not require complex and heavy structural supports during the launch of the satellite.

Another objective is to provide an imaging mirror which would be fabricated in space.

Yet another objective is to provide an imaging mirror which would be lightweight.

Yet another objective is to provide an imaging mirror which would be repairable in orbit, without additional instruments.

### SUMMARY OF THE INVENTION

In accordance with the present invention, a miniature cube-sat with an imaging mirror being fabricated on-orbit is described.

The mirror paraboloid shape is formed by a liquid photopolymer or other liquid precursors which assume paraboloid shape upon certain rotational maneuvers of the satellite itself.

When a photopolymer is used for mirror material it is subsequently solidified by crosslinking by exposing it to UV illumination supplied by the system's light sources.

If an alternative liquid precursor, such as a molten metal, thermoset- and thermoplastic polymers, or two-part epoxy is used it is allowed to cool and solidify prior to cessation of satellite movement to create the mirror.

Shape-memory materials are used extensively for erecting and positioning mirror supports and the completed mirror.

The shape-memory mirror support is formed into its desired deployed shape during its manufacturing and subsequent ‘training’ where it is mechanically restrained in the deployed geometry while being heated at—or above the phase- or glass transition temperature of the shape-memory material and is allowed to cool off. Thereafter, mechanical restraints are removed at which point the support remains in its deployed configuration. The support is then radially folded/corrugated to enable its efficient storage prior to deployment.

The shape-memory mirror support remains in its stowed configuration until deployment. At deployment it is heated to—or above the phase—or glass transition temperature of the shape-memory material, and returns to its original ‘as-trained’ shape.

Additionally, an extendable boom is utilized to erect the mirror and the imaging system into their operating position and configuration. Several boom embodiments presented, such as multi-stage telescopic and single-piece tubular corrugated and coiled types. They rely on the shape-memory materials' properties for their deployment: the telescopic booms by action of several types of shape-memory actuators and single-piece booms themselves being constructed of shape-memory materials.

Articles made with shape-memory materials, their fabrication, ‘training’ and usage are known in their respective arts.

A satellite equipped with such an imaging mirror can be thought of a type of smart space-based telescope.

### PRIOR ART

It has been known since 1600's that a surface of liquid spun around a vertical axis assumes a paraboloid shape. On the surface of the Earth paraboloid telescope mirrors created with spinning layer of liquid mercury have also been known for some time. Indeed, relatively recent NASA Liquid Mirror Telescope (‘LMT’) and Canadian Large Zenith Telescope (‘LZT’) are just examples of such spinning mercury large telescopes. These telescopes share a common shortcoming, however: they can only be pointed vertically (i.e. towards zenith) and cannot be aimed in other directions.

There are also proposals for paraboloid mirrors spin-cast from epoxy (US H2123 to Mollenhauer et al., U.S. Pat. No. 6,254,243 to Scrivens, U.S. Pat. No. 6,533,426 to Carreras et al.), made of magnetic rheological fluids, etc.

There have also been non-industrial attempts to cast paraboloid mirrors with epoxy materials utilizing horizontal rotational tables, with varying success.

There have also been several deployable paraboloid antenna reflectors based on shape-memory materials which resemble in their shape the final shape of the proposed paraboloid mirror.

For example, U.S. Pat. No. 7,710,348 to Taylor et al. teaches a deployable antenna reflector which utilizes a shape-memory element to open conventional rigid ribs supporting a flexible reflector.

U.S. Pat. Nos. 8,259,033 and 9,281,569, both to Taylor et al. teach a deployable antenna reflector with longitudinal and circumferential shape-memory stiffeners supporting a reflective elastic material.

None of the prior art above suggests or teaches a paraboloid mirror created in space.

None of the prior art above suggests or teaches a deployable shape-memory mirror support created from a folded/corrugated preform.

None of the prior art above suggests or teaches an extendable boom structure actuated by—or constructed from shape—memory materials.

Also, none of the prior art above suggests or teaches a satellite which would create its own paraboloid mirror while in space, as per instant invention.

None of the prior art suggests or teaches a space borne repairable mirror.

### Objects and Advantages

Large Optical Apertures Possible

In contrast to the prior art mentioned hereinabove, the present invention describes a satellite which would be, while being compact at launch, when in space create and deploy a paraboloid mirror of the size enabling imaging at improved resolution. For example, a ‘3U’ (300×100×100 mm³) small satellite can have a mirror of up to 1 meter in diameter.

Having a large aperture (diameter) of the optical component, such as a mirror, is critical for improved imaging, since imaging resolution is directly related to the size of the aperture:

$${α}_{D} = 1.22 \frac{λ}{D} \qquad ( 1 )$$

### Where

α_{D} is angular resolution (smaller value is desirable)
λ is wavelength of light
D is the aperture (optical element effective diameter)

In low-/micro-/zero gravity environments, the size of the mirror support and its boom are limited only by structural rigidity requirements during satellite maneuvers and their ultimate strength during mirror generation maneuvers.

Thus, very large mirror supports and the resulting mirrors are possible to construct in space.

High Volumetric Storage Efficiency

The mirror support in its stowed configuration will not require extensive specialized supports for protection during launch due to its size and weight.

The resulting mirror can also be much lighter than the present ones, saving on launch cost and complexity, and saving the on-board propellant for on-orbit satellite maneuvering. Both the material used (preferably, photopolymer) and the volume (a thin paraboloid layer) of the mirror material can be orders of magnitude lighter than even the lightest present solid paraboloid space mirrors.

The mirror support of the instant satellite system is compactly packaged and requires merely application of heat for its deployment. Without any specialized mechanical deployment apparatus, the resulting assembly offers a very dense package. The required heaters can be very compact as well, or the mirror support can be heated directly by passing electric current through it.

Light Weight

The very mirror support comprises a thin lightweight shell. In addition, due to the absence of the relatively heavy mechanical deployment drives and their associated interfaces, the weight of instant mirror system is greatly reduced. The required heaters can be very thin and lightweight and in some applications the actuating heat can be generated by passing electric current directly through the reflector and feeds themselves. A completely passive heating and subsequent mirror support deployment can be achieved by exposing the mirror system elements to sunlight by appropriately maneuvering the satellite. In the vacuum of space, solar heating can be considerable.

Simplified Construction

The instant mirror system comprises a very limited number of parts. There are basically no separate ‘actuators’ per se, other than optional dedicated heaters, with the system elements literally deploying themselves upon application of heat, by utilizing elastic mechanical energy stored at the time of their packaging. The deployment heaters of instant invention are much smaller and less complicated than present mechanical actuators of similar structures.

Improved Reliability, Easier Redundancy Implementation

With thermal actuation of instant invention replacing present electro-mechanical actuators the instant imaging system is much more reliable, since the only moving parts are the very system elements themselves. With timed heater activation very specific and precise deployment sequences are possible to minimize the risk of malfunction or mechanical interference.

Since it is much easier to provide redundancy to an electrically heated deployment system than to a mechanical actuator(s)-based one, the shape-memory based mirror support system can have enhanced redundancy of its deployment apparatus.

High Stored Mechanical Energy

The shape-memory materials used for the mirror support and the boom store considerable mechanical elastic energy at the time of their packaging and can generate considerable forces during deployment to overcome potential adhesions, friction and snags. This improves overall reliability of the deployment and therefore, the reliability of the entire system.

Optional Deployment by Sunlight

As mentioned above, since heating of satellite components by solar radiation in space can be considerable, the instant mirror system elements can be exposed to sunlight instead of heaters for deployment. This also can be used as a backup procedure in case of heater malfunction.

Optional Precursor Material Curing by Sunlight

Solar radiation in space contains large amount of UV light which can be advantageously used to cure the mirror photopolymer material precursor.

In-Space Mirror Testing and Repair/Regeneration

The completed mirror can be tested by pointing it towards a star (a near-perfect point light source) and analyzing the resulting image. If required, the mirror can be repaired/re-cast in space by repeating its casting/solidification procedures

### BRIEF DESCRIPTION OF THE DRAWINGS

FIG. 1 is a perspective view of the imaging satellite 50 in storage and launch configuration.

FIG. 2 is a perspective exploded view of the mirror support 40, and the associated heaters 55a, 55b, 55c, precursor material container 30, and imaging/curing/coating system 70 in stowed configuration.

FIG. 3 is a perspective bottom view of the mirror support

FIG. 4 is a perspective view of the mirror support construction

FIG. 5 is a cross-section view taken along line 5-5 of mirror support 40 on FIG. 4.

FIG. 6 is a cross-sectional view taken along line 5-5 of mirror support 40 on FIG. 4 and electrical actuation schematic.

FIG. 7 is a cross-sectional view taken along line 5-5 of mirror support 40 on FIG. 4 and the associated heaters.

FIG. 8 is perspective view of the strut 160.

FIG. 9 is a cross-sectional view of the alternate embodiment of strut 160 taken along line 9-9 on FIG. 8.

FIG. 10 is a cross-sectional view taken along line 10-10 on FIG. 5 of mirror support 40.

FIG. 11 is a cross-sectional view of a solid cylindrical strut 160 before and after actuation.

FIG. 12 is a cross-sectional view of a tubular strut variant 27 before and after actuation.

FIG. 13 is a perspective view of the satellite with the mirror assembly partially deployed

FIG. 14 is a perspective view of the satellite with mirror supports deployed prior to mirror generation

FIG. 15 is a perspective view of satellite with the mirror created.

FIG. 16 is a cross-sectional view taken along line A-A on FIG. 15 of mirror support 40 in its deployed configuration 40a showing mirror material flow.

FIG. 17 is a fragmentary cross-section view taken along line A-A on FIG. 15 illustrating the formation of the parabolic shape of the mirror.

FIGS. 18-20 are perspective views of variants of mirror material container assembly.

FIG. 21 is a perspective view of the imaging, photopolymer curing and coating assembly.

FIG. 22 is a cross-section view taken along the line 22-22 on FIG. 21.

FIG. 23 is a fragmentary cross-section view 23 on FIG. 22.

FIG. 24 is a perspective view of the deployable boom 120 in stowed configuration.

FIG. 25 is a perspective view of the deployable boom 120 in its deployed configuration 120a.

FIG. 26 is a schematic of heating mechanism for struts 160.

FIG. 27 is alternative schematic of heating mechanism for struts 160.

FIG. 28 is a perspective view of the telescopic deployable boom 140 in its stowed configuration.

FIG. 29 is a perspective view of the telescopic deployable boom 140 in its deployed configuration 140a.

FIG. 30 is a perspective view of the corrugated deployable boom 150 in its stowed configuration.

FIG. 31 is a cross section taken along line 31-31 of the FIG. 30.

FIG. 32 is a perspective view of the corrugated boom 150 with attached mirror support 40, in their stowed configuration.

FIG. 33 is a perspective exploded view of the mirror support 40, optional heaters 55a, 55b, 55c, imaging/curing/coating assembly 70, pivoting assembly 75 and corrugated boom 150, all in stowed configuration.

FIG. 34 is a perspective view of the corrugated boom 150 in its deployed configuration 150a.

FIG. 35 is a perspective exploded view of the tubular coiled boom 190 in stowed configuration.

FIG. 36 is a perspective view of the tubular coiled boom 190 in its deployed configuration 190a.

FIG. 37 is a perspective view of satellite 50 with mirror support 40a and tubular boom 120a in their deployed configurations.

FIG. 38 is a perspective view of satellite 50 with mirror support 40a in pivoted configuration.

FIG. 39 is a fragmentary view 39 on FIG. 38.

FIG. 40 is a chart of mirror support deployment sequence.

FIG. 41 is a chart of mirror generation sequence.

### DESCRIPTION OF THE EMBODIMENTS

In the foregoing description like components are labeled by the like numerals.

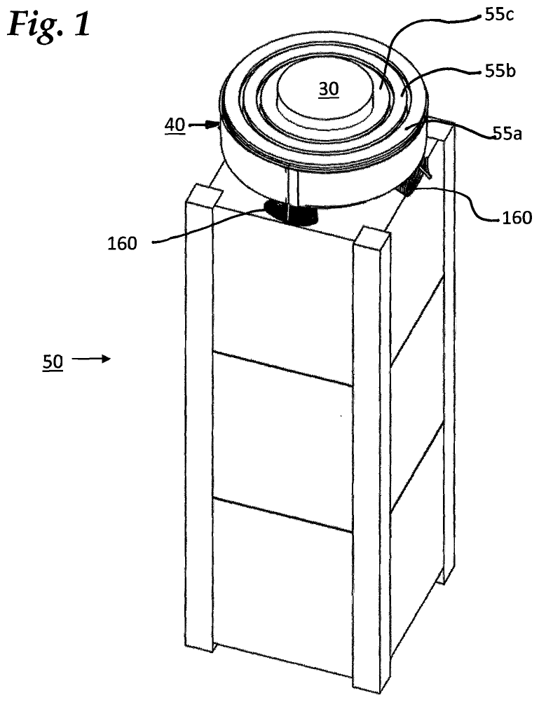

Referring to FIG. 1, in its pre-deployment stowed configuration satellite 50 comprises satellite body and attached to it a mirror support 40, also in its stowed configuration, together with optional heaters 55a, 55b, 55c, and mirror precursor material container 30. Mirror support 40 is held by deployable struts 160, also shown in their stowed coiled configuration.

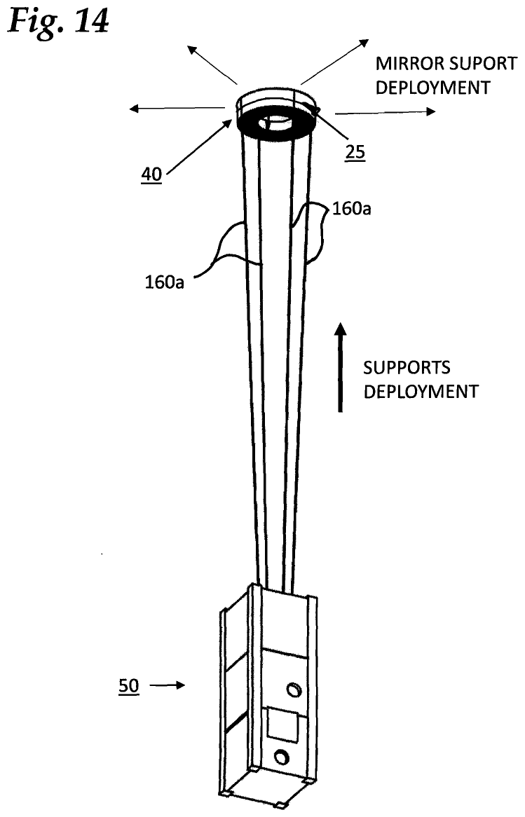

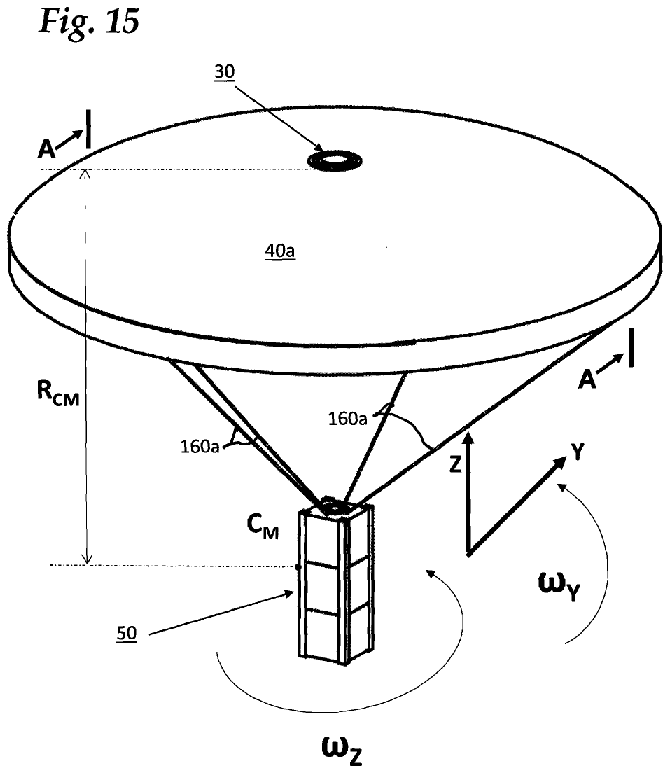

Referring to FIG. 14, mirror support 40 is displaced by actuating struts 160. It is then transformed into its deployed configuration 40a via heating by electric current passing directly through it, or by activating optional heaters 55a, 55b, 55c heaters, as shown on FIG. 15.

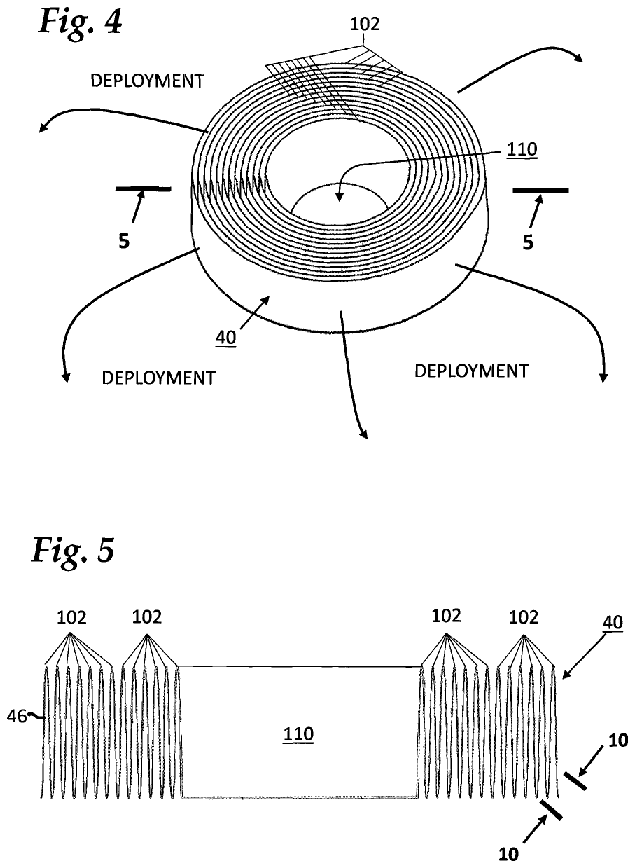

Mirror support 40 comprises a radially corrugated circular structure made of a shape memory material(s). According to FIGS. 4 and 5, pleats 102 are disposed around a cavity 110 which houses imaging/curing/coating system 70 when assembled into the system. Upon application of heat, support 40 assumes a generally paraboloid shape 40a. Outermost pleat 46 becomes an outer wall for containment of mirror precursor material 60 upon deployment of mirror support 40 and during mirror surface 64 generation.

The mirror surface generation then proceeds with satellite 50 spinning in two orthogonal axes.

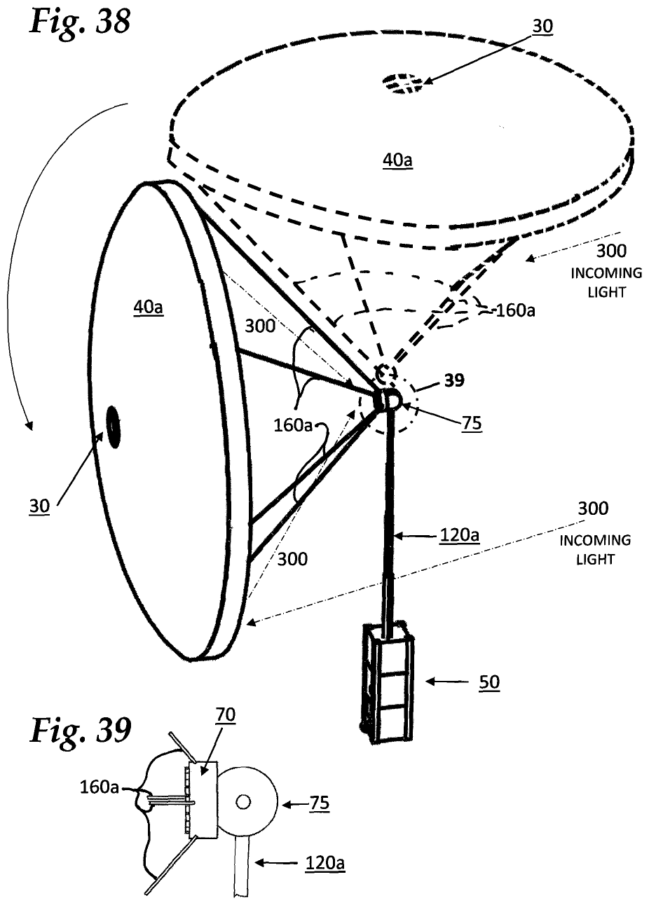

As shown on FIG. 38, upon deployment of the mirror support 40a and creation of the mirror surface 64, boom 120 is extended to deploy the completed mirror and positioning it via tilting mechanism 75 into its operational attitude.

The shape-memory materials used in the instant mirror support construction may include shape-memory alloys (‘SMAs’) or shape-memory polymers (‘SMPs’).

Shape-memory alloys comprise numerous alloys such as AgCd, AuCd, cobalt-, copper-, iron-, nickel- and titanium-based, with most well-known and used being Cu—Al—Ni and Ni—Ti alloys (the latter known as ‘nitinols’).

Shape-memory polymers comprise linear block polymers such as polyurethanes, polyurethanes with ionic or mesogenic components made by prepolymer method, block copolymer of polyethylene terephthalate (PET) and polyethyleneoxide (PEO), block copolymers containing polystyrene and poly(1,4-butadiene), and an ABA triblock copolymer made from poly(2-methyl-2-oxazoline) and polytetrahydrofuran.

Also, cross-linked PEO-PET block copolymers and PEEK can be used as shape-memory elements of instant invention.

Some of these SMPs can be made to contain carbon which makes them electrically conductive. This conductivity can be advantageous for their direct heating with electrical current of the mirror support and boom made from them.

### Operation

As shown on FIG. 1, prior to and during launch mirror support 40 is stowed on satellite 50. Mirror precursor material container assembly 30 is stowed within mirror support 40. Mirror precursor material 60 is kept inside container assembly 30.

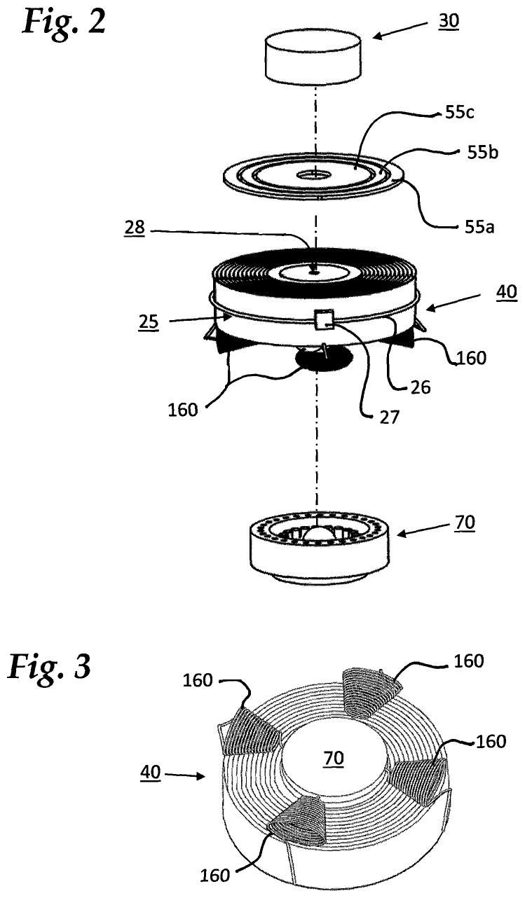

FIG. 2 shows interrelationship between mirror support 40, mirror precursor material container 30, optional heaters 55a, 55b, 55c and imaging/curing/coating system 70.

Mirror Support Deployment

As shown on FIG. 14 at deployment, shape memory support struts 160 are extended by application of heat or direct heating by electrical current.

Heat can be applied to struts 160 by heaters 200 and 202 as shown on FIG. 26. In the same figure, electric current supplied by source 210 proceeds through heater 200, through connector 15 and returns to source 210 via heater 202. Electric current flowing through heaters 200 and 202 heats them up, and they in turn heat up strut 160.

An alternative heating mechanism of struts 160 is shown on FIG. 27. Electric current supplied by electrical source 210 proceeds through contact 15a, through strut 160 itself and through second contact 15a back to source 210, in the process heating strut 160.

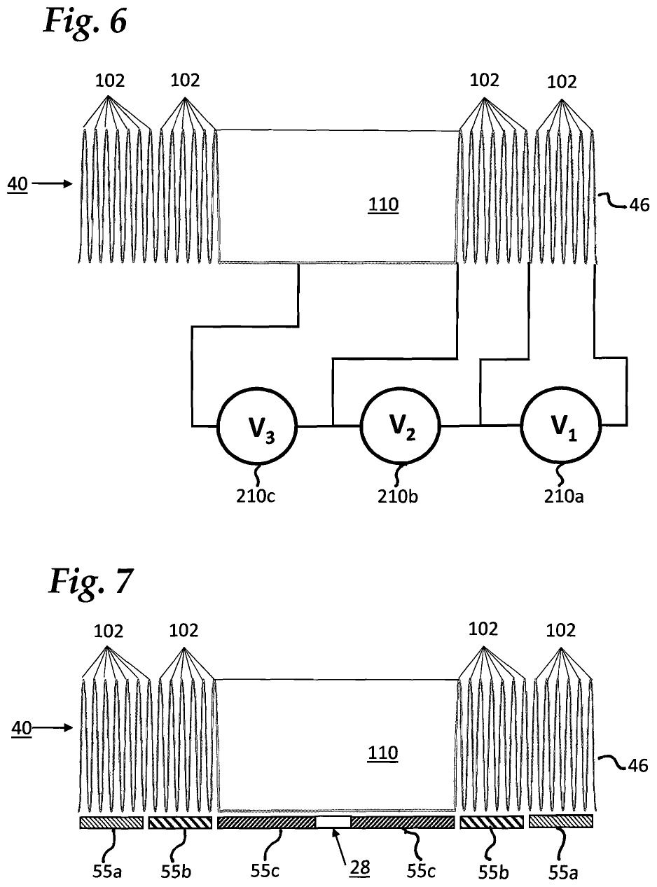

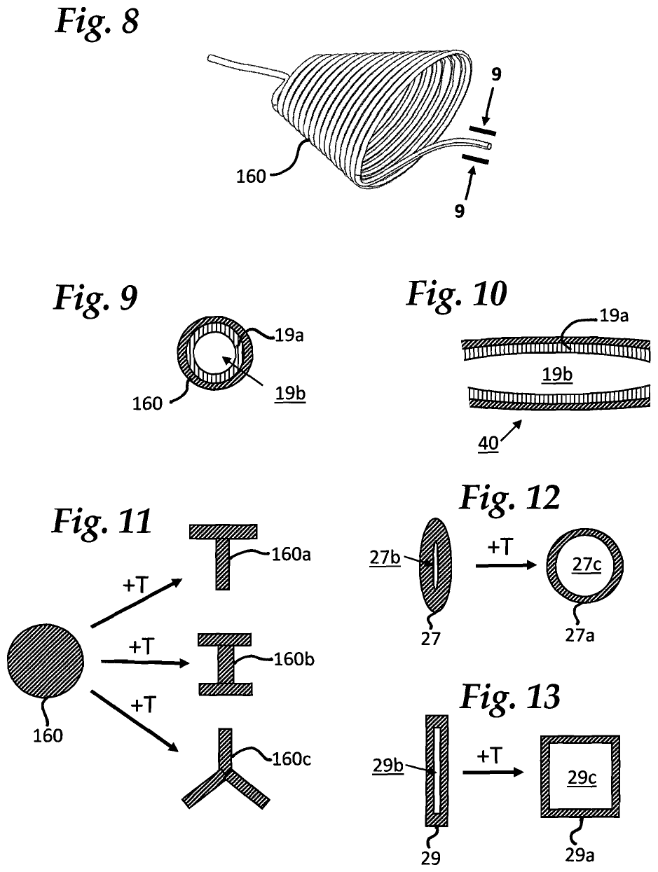

After deployment of struts 160, mirror support 40 is subsequently unfolded into its deployed configuration 40a by preferably sequentially activating heaters 55a, 55b and 55c, as shown on FIG. 7, or by passing electric current directly through it, as shown on FIG. 6, with preferably sequential activation of electric sources 210a, 210b and 210c.

Shape memory materials utilized in support 40 and struts 160 construction, such as metallic Ni-based alloys are advantageously suited for direct heating by electric current, as they possess high electrical resistivity.

Voltage sources 210a, 210b and 210c can be combined into a single source attached in the center and outer edge of support 40, if it is determined that a reliable deployment can be achieved with simultaneous heating of all parts of support 40.

When support 40 is directly heated electrically heaters 55a, 55b and 55c are not required.

Paraboloid Mirror Creation

As shown on FIG. 15 to create the paraboloid mirror surface, satellite 50 commences rotation simultaneously around two axes. Satellite 50 spins around its center of mass C_{M} in Y-axis with angular velocity ω_{Y} and simultaneously around its longitudinal Z-axis with angular velocity ω_{Z}. This compound spinning generates required forces on the liquid precursor material 60 for it to assume the desired paraboloid shape. This spinning can be effected via compressed gas jets, pyrotechnical charges or internal rotating inertial masses.

Rotation around the satellite's Y-axis creates a centripetal force similar to the gravitation force on the Earth's surface. Rotation around the satellite's Z-axis creates its own centripetal force which distributes liquid mirror material 60 onto deployed mirror support 40a. The cooperative action of these two forces creates a paraboloid mirror surface.

The focal length of the resulting mirror can be calculated from the following equation (2).

$$f = \frac{{R}_{C M}}{2} {( \frac{{ω}_{Y}}{{ω}_{Z}} )}^{2} \qquad ( 2 )$$

### Where

f is the focus length of the resulting paraboloid mirror
R_{CM} is the radius of rotation around satellite center of mass
ω_{Y} is angular velocity around satellite's Y-axis
ω_{Z} is angular velocity around satellite's Z-axis

The Coriolis force contribution and liquid surface tension of mirror material 60, while present, to a first approximation are not included in this analysis. It is generally accepted that the Coriolis force will effectively tilt the center line of the created paraboloid. This tilt is predictable and ascertainable from the system operation parameters and will be readily compensated for by the mechanical design of the mirror support and optical system layout. Proper selection of the mirror material 60 and intrinsic material or coating of support 40 would ensure its proper wetting by material 60.

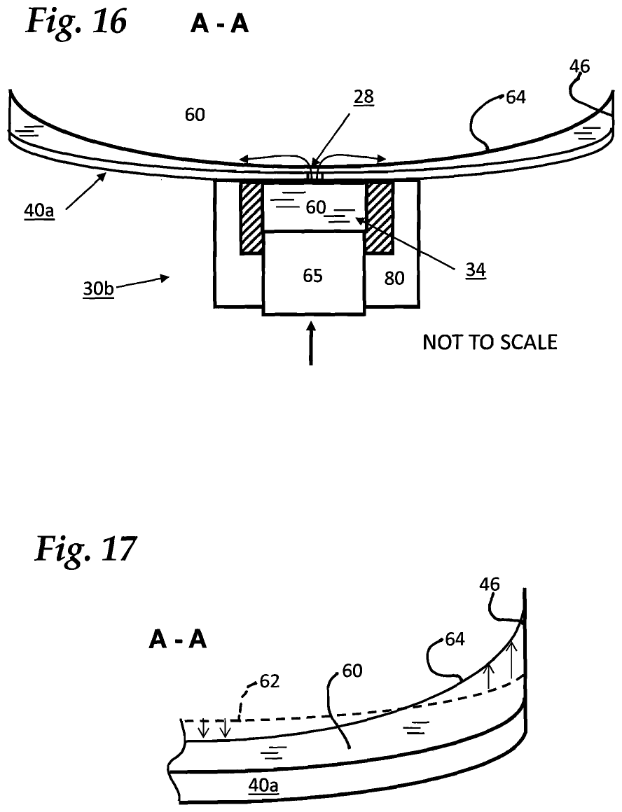

Liquid mirror material 60 held in container assembly 30 is ejected onto deployed support 40a by the action of piston 65 via aperture 28 per FIG. 16.

When liquid mirror material 60 covers the surfaces of support 40a, upon rotation its outer surface transforms from initially flat layer 62 into a smooth paraboloid surface 64 as shown on FIG. 17.

In case of molten/two part epoxy/thermosetting polymers used as precursor, liquid mirror material 60 is then permitted to cool and solidify, at which point the rotation of the satellite can be stopped. The cooling rate of material 60 may have to be controlled for a particular mirror material, for example a flash cooling to create an amorphous metal ‘glass’ with superior surface quality.

Metals and alloys with low melting temperature include sodium (Na), potassium (K), indium (In), gadolinium (Ga), tin (Sn), lead (Pb) and mercury (Hg) as well as alloys of these metals.

Thermo-setting polymers are also suitable, such as polyesters, phenolic resins, vinyl esters, polyurethane; silicones, polyamides, polyamide-imides, and others.

Thermoplastic polymers such as polypropylene, polyethylene, polyvinylchloride, polystyrene, polyethylenetheraphthalate and polycarbonate and others can be also be used.

Curing/Solidification of Photopolymer Precursor Material

In case of a photopolymer precursor, liquid mirror material 60 is cured by exposure to ultraviolet (′UV) light supplied by UV light source or sources 90. Most of UV-curable materials require UV irradiation in the 240-405 nm wavelength range. Such illumination is achievable with UV light-emitting diodes (LEDs) or lasers. Such LEDs are commercially available. For example, UV LED Model 6868 by Inolux Company (San Jose, Calif., USA) produces 10 Watts of optical output at 365 nm wavelength while occupying a relatively small 6.8×6.8×3.7 mm³ envelope suitable for compact co-location of many such LEDs for a powerful precursor curing solution which would be capable of reliable and fast curing of photopolymer precursor.

Photopolymers are widely used in industry as potting and adhesive compounds. Commonly used photopolymer materials comprise cycloaliphatic epoxies, cyanoacrylates and such. For example, UV-curable polymer Model UV18Med by Master Bond Corporation (Hackensack, N.J., USA) is cured by exposure to 320-365 nm UV light source, does not contain or create volatile compounds and has an exceptionally low shrinkage upon curing. Another example is a UV22 nanosilica-filled UV-curable photopolymer system by Master Bond, Inc. which has high dimensional stability, very low thermal expansion coefficient and meets NASA low outgassing requirements, thus making it suitable for the instant application.

Reflective Coating(s) Deposition

Metallic precursor materials intrinsically possess high reflectivity and they do not generally require reflective coatings.

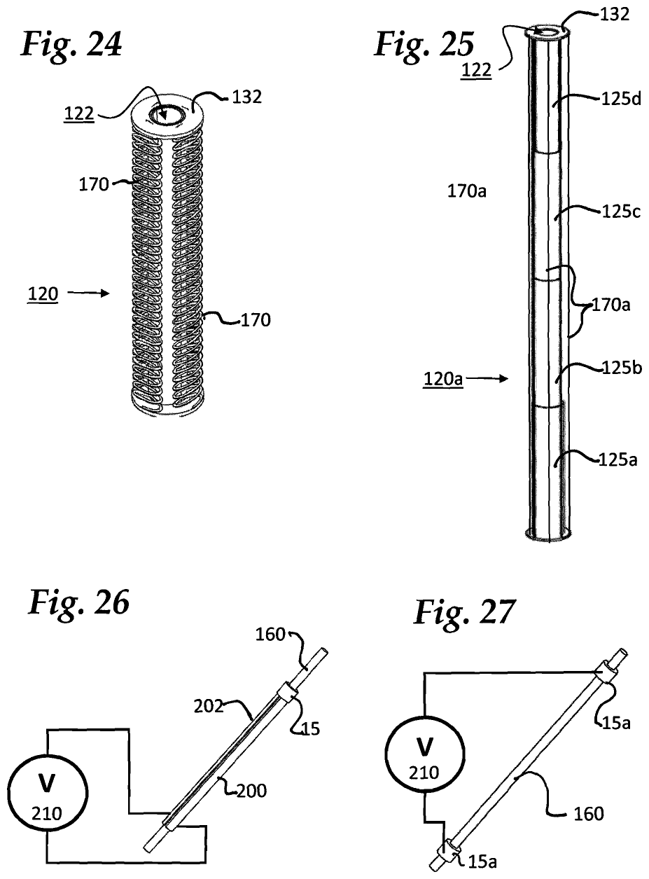

In contrast, since cured photopolymers, two-part epoxies or thermoset or thermoplastic polymers do not generally possess high intrinsic reflectivity, they have to be coated with thin metallic or dielectric reflective films, after the mirror is solidified. To accomplish this an evaporative source(s) 98 is used to deposit a reflective coating or a set of coatings onto the completed mirror. The source 98 can have multiple chambers each containing a separate coating material and an output opening 99 facing mirror 40 surface. To enable deposition, coating material is heated or vaporized by heater 260 and then its vapor accelerated towards the mirror surface by a high voltage source 250 connected between coating material 300 and accelerating grid 280. To concentrate the electric field and enable more efficient emission of the coating atoms, the shape of coating material source 300 can be made into a sharp-tipped cone, as shown on FIGS. 22 and 23. Since the coating operation is conducted in the deep vacuum of space, this environment is uniquely suitable for in-situ coating deposition.

Providing momentum to the coating particles via accelerating voltage also helps to keep their stream pointed onto the mirror surface and minimize or eliminate its spillover and possible contamination of the adjacent satellite structures. Any coating particles not intercepted by mirror support 40a will be launched into space and away from satellite 50 thanks to their momentum.

To further prevent coating materials from settling onto- and potentially contaminating the nearby imaging system 24, it can be recessed with respect to the coater output openings 98 as shown on FIGS. 22 and 23.

Several coating sources utilizing various materials can be used to deposit multi-layer reflective coatings, simultaneously or sequentially. Coaters 98 are designed to expressly have such a capability. The coating materials can comprise metals, for example gold (Au), silver (Ag) or aluminum (Al), or dielectric materials such as SiO₂, Si₃N₄, CaF₂, GeO₂, Mg F₂, Al₂O₃. High reflectivity multilayer coatings utilizing these and similar materials are well known in the art. For example, high reflectivity multilayer coatings are customarily made with alternating layers of materials with low refractive indices such as magnesium fluoride (MgF₂) and silicon dioxide (SiO₂) and materials with large refractive indices, such as zinc sulfide (ZnS) and titanium dioxide (TiO₂). For high reflectivities in extreme ultra-violet (EUV) alternating layers of molybdenum (Mo) or tungsten (W) can be interspersed with lightweight materials such as silicon (Si).

Since the mirror operates exclusively in the deep vacuum of space, chemically reactive materials otherwise unsuitable for terrestrial applications, such as alkali metals, may also be readily used for coatings. Advantageously, some alkali metals, such as potassium (K) mentioned hereinabove, have unique reflectance properties which can be advantageously exploited in space.

Boom Deployment

An extendable boom is used to relocate/reorient the created mirror with respect to the rest of satellite 50 to enable un-obstructed field-of-view of the mirror.

Telescopic boom 120 is stored inside satellite 50 body.

As shown on FIGS. 24 and 25 boom 120 comprises several nested telescopic tubular sections 125a, 125b, 125c and 125d which are extended by the action of shape-memory actuators 170 which are coiled for stowage. Actuators 170 extend to their deployed shape 170a by action of heat, in turn extending boom 120 into its deployed configuration 120a.

Tilting the Completed Mirror

It is important to prevent satellite 50 from obscuring field of view of imager 24 and permit light 300 from the observed object to reach imager 24. This is achieved by tilting mirror support 40a and re-pointing it away from satellite 50.

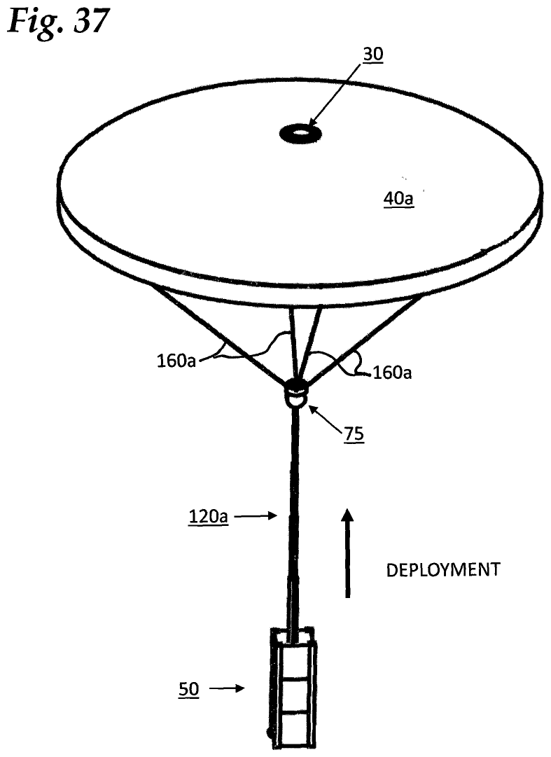

As shown on FIGS. 37 and 38 to position the completed mirror after boom 120a is extended, pivot drive 75 is activated and tilts mirror support 40a into its operational position.

Power and signal cables to imaging assembly 24, curing source(s) 90 and coater(s) 98 are routed inside lumen 122 of boom 120a. They may be pre-coiled or folded to facilitate their stretching as the boom is deployed. Such cable configurations are well known in the art.

Summary of Mirror Support Deployment and Surface Creation Operations

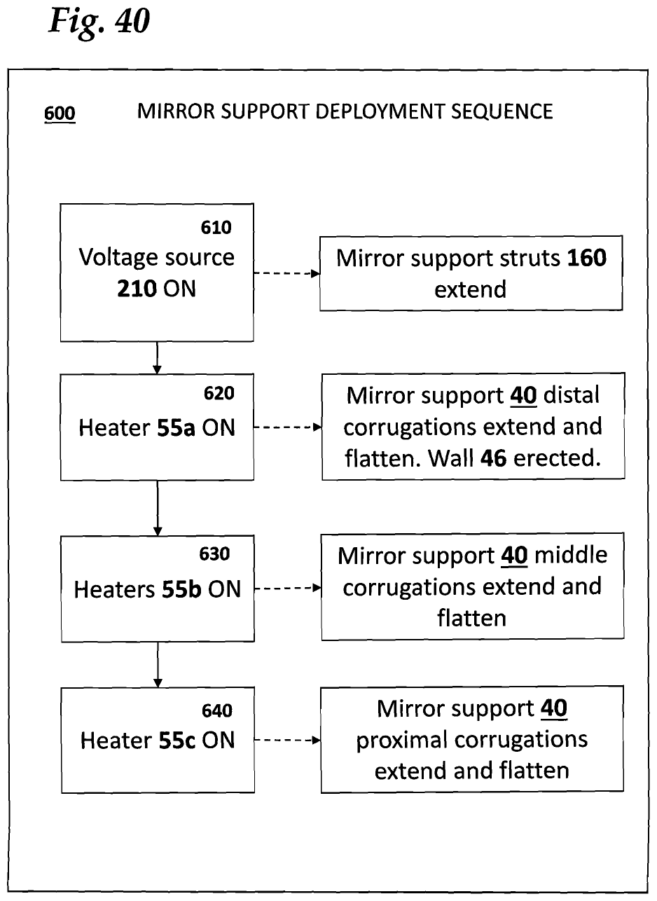

Referring to FIG. 40, sequence 600 pertains to deployment of mirror support 40. Struts 160 are extended by activating voltage source 210 (step 610) and passing electric current directly through struts 160. Support 40 is controllably deployed by a timed action of heaters 55a, 55b and 55c into its deployed configuration 40a through 640): first the distal pleats 102 are activated by action of heater 55a (step 620), then the middle pleats 102 are activated by heater 55b (step 630), and finally the proximal pleats are activated by heater 55c (step 640). The outer (distal) portion of support 40 upon full deployment forms circular wall 46 which supports mirror precursor material 60 when paraboloid mirror surface is formed.

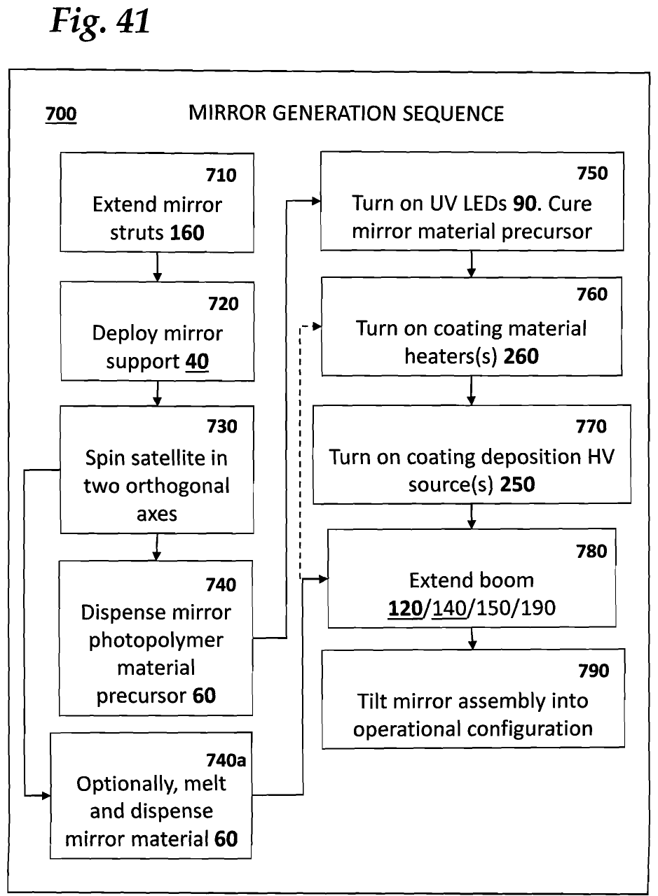

Referring to FIG. 41, in sequence 700 which pertains to mirror surface generation, supports 160 are extended by passing through them electric current supplied by heating voltage source 210 (step 710). Subsequently, support 40 is deployed and assumes a paraboloid shape 40a (step 720). Satellite 50 is then spun around two orthogonal axes. Photopolymer precursor material 60 is then dispensed into support 40a and, still in liquid state, creates a paraboloid surface due to satellite spinning action (step 740). Precursor 60 is then cured into solid paraboloid form by its exposure to UV light(s) 90 (step 750).

If material 60 is not a photopolymer and has to be softened/melted prior to dispensing it is heated by heater 68 of precursor container 30b (step 740a).

For photopolymer precursor (also, optionally, for non-photopolymer precursors), coating operation commences by turning on coating heater(s) 260 (step 760) and deposition high-voltage source(s) 250 (step 770).

After paraboloid mirror surface 64 is created and optionally coated, boom 120 (or its variants 140, 150 and 190) is extended (step 780).

Subsequently, mirror support 40a with formed mirror surface is tilted by pivot drive 75 into mirror operational position.

### Additional Embodiments

Mirror Support Variants

Mirror support 40 can be implemented in several configurations. In addition to deployment via heating by heaters 55a, 55b and 55c, support 40 can be constructed to comprise a hollow heat pipe-type structure, which can be heated from its center portion only. The advantage of a heat pipe is that it provides fast even heating even at its distal end via convection of the working fluid and its vapor and does not rely on a relatively slow heat diffusion from the center of support towards its periphery. FIG. 10 shows a cross section of mirror support 40 executed in heat pipe technology taken along the line 10-10 on FIG. 5. Support 40 is made hollow with internal lumen 19b containing wick 19a for transport of vapor and liquid phases of heat pipe working fluid, respectively.

Mirror support 40 can also be made self-opening by capitalizing on super-elastic properties of shape-memory materials, such as, in particular, NiTi (‘nitinol’) alloys. At above their phase-transition temperatures such alloys exhibit super-elastic properties which are characterized by very large elastic coefficients: the items made from them after removal of constraint return to their original shape even after being greatly deformed. Mirror support 40 made from these materials and operated in their super-elastic mode (vs. temperature-sensitive shape-memory mode), would unfold on their own on-orbit after being initially compressed into stowed configuration. A restraining mechanism 25 shown on FIGS. 2 and 14 is fitted onto the folded support 40 and prevents its premature opening. Restraining mechanism 25 comprises restraining band 26 kept closed by locking mechanism 27. Band 26 keeps super-elastic support 40 from unfolding until locking mechanism 27 is unlocked and allows band 26 to open, thus in turn allowing support 40 to unfold into its deployed configuration 40a. Various mechanical release mechanisms, such as melting polymer links, can be used in mechanism 27 and are well known in the art.

Mirror Testing, Calibration and Repair

To verify mirror shape and to test its surface quality and alignment satellite 50 is oriented to point the mirror towards a bright star, which can serve as a near-ideal point light source.

By analyzing the shape and size of the image of the star the surface quality of the mirror, its shape and alignment can be ascertained. By utilizing the results of these measurements all subsequent images produced by the imaging system 24 can be digitally corrected if required, since the mirror shape and alignment in space are assumed to remain unperturbed. The calibration and verification can be repeated if there is a suspicion that the mirror shape and alignment have changed in response to, for instance, an inadvertent overheating by the sun.

If the mirror has been damaged, deformed or its surface aged, or if there was a defect produced during its casting, it can potentially be re-melted and re-cast anew, if a suitable precursor material is used, for example, a metal alloy with low-melting temperature.

To re-cast the mirror surface with a molten precursor, the precursor material melting, casting and coating (if required) operations will be repeated. The entire mirror can be heated for the material to melt, or a new batch of the molten precursor material deposited onto the existing material layer. In the former case, mirror support 40a will have to have a heater or heaters pre-installed. Mirror support 40a will be tilted into the starting position, and satellite 50 will again be spun along two orthogonal axes to re-generate parabolic mirror surface. The relative rates of rotation ω_{Y} and ω_{Z} will be changed in order to compensate for the length of the extended boom 120a.

Alternatively, the mirror can be over-cast with a UV-curable photopolymer. To achieve this, mirror support 40a is tilted back to its original position, an additional batch of liquid photopolymer 60 is dispensed onto the previously solidified mirror surface 64. Satellite 50 is then re-spun at rates compensating for the extended boom 120a, to spread photopolymer 60 and to form new paraboloid surface 64, and then photopolymer 60 is cured with UV light source(s) 90 and coated as previously. This operation will necessitate an additional capacity of the precursor material holding tank 30, or additional precursor holding tanks, or a controlled dispensing action of material expelling piston 65 which will not dispense the entire volume of precursor 60 in the first mirror forming operation, but will preserve some for potential re-casting operations. A dedicated heater may be required to maintain precursor 60 in liquid form, or to heat/thaw it prior to dispensing.

Curing light source(s) 90 do not have to produce just an ultraviolet light in order to cure precursor 60, but visible or even infrared light can be used instead. Some photopolymers can be cured by visible light, as described in U.S. Pat. No. 9,902,860 to Li et al., or even by either UV or IR radiation per U.S. Pat. No. 5,466,557 to Haley et al.

Additionally, cross-linking of precursor polymeric material(s) can be accomplished by exposing them to other types of radiation, such as for example, ionizing. This technique is commonly used in manufacturing of the heat-shrink tubing.

Boom Variants

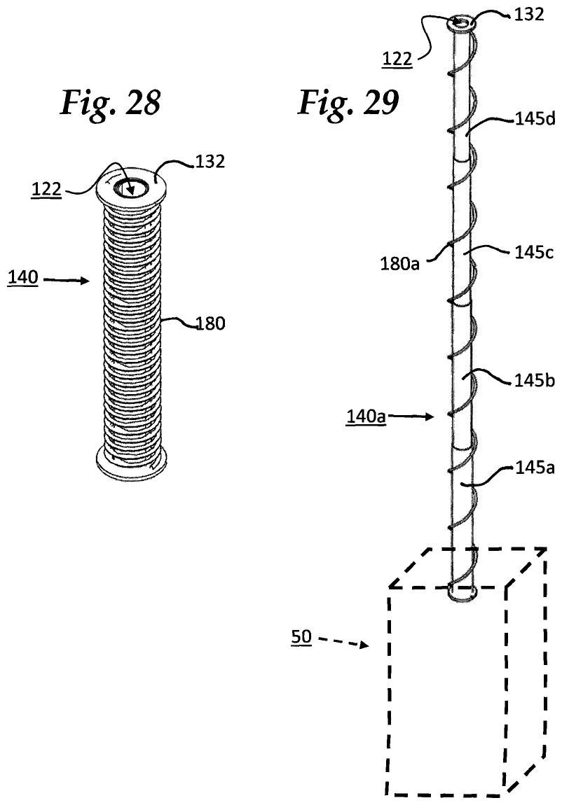

The system's boom can be realized in several configurations. Telescopic boom assembly 140 shown on FIGS. 28 and 29 comprises nesting telescopic sections 145a, 145b, 145c and 145d which are deployed by the action of extending shape-memory coil actuator 180 acting on flange 132 attached to section 145d. Coil 180 is stowed in its compact configuration prior to boom deployment and straightens to its extended form 180a upon application of heat, either indirectly from an external heat source (not shown) or by passing electrical current directly through it.

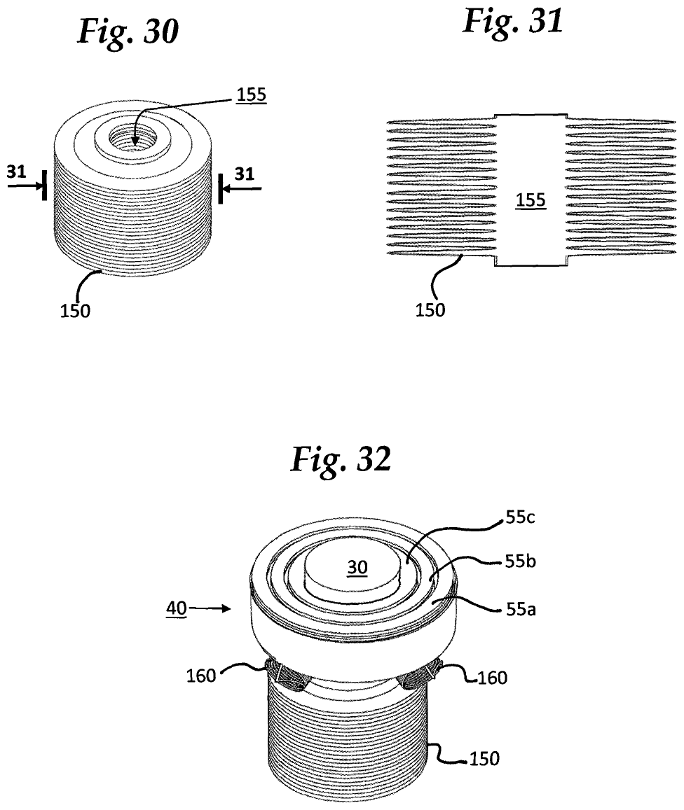

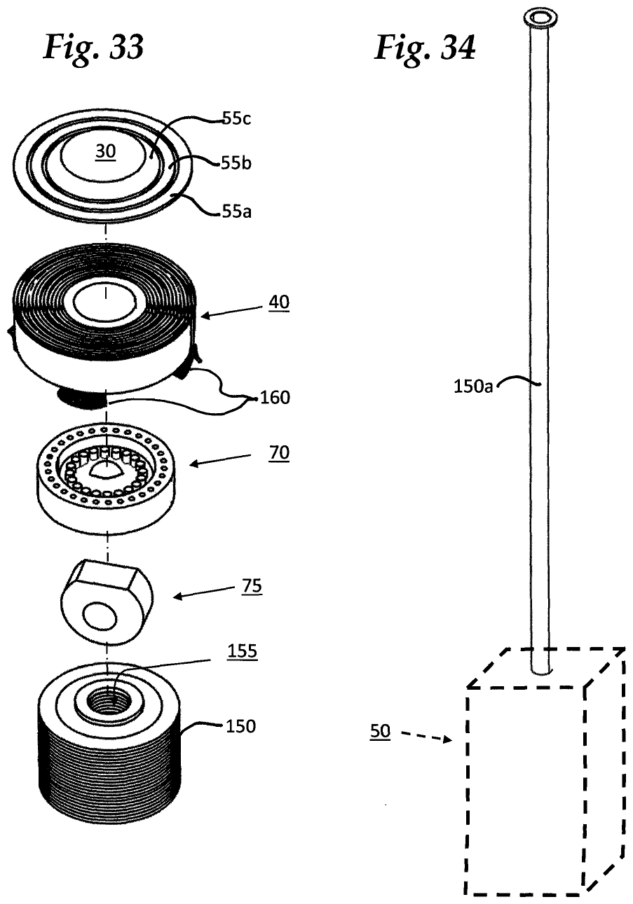

Corrugated boom 150 shown on FIGS. 30 through 34 is itself made from shape-memory material and comprises longitudinal pleats 156 disposed around lumen 158. Boom 150 is stowed in its compressed configuration prior to deployment and assumes extended tubular shape 150a upon application of heat.

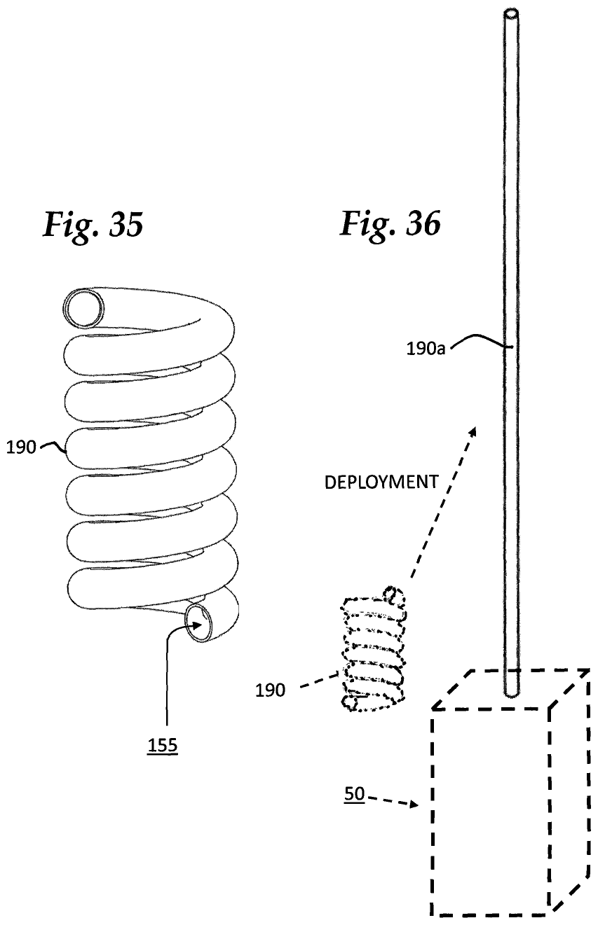

Coiled tubular boom 190 shown on FIGS. 35 and 36 is also made from shape-memory material and is extended/uncoiled to its deployed configuration 190a by application of external heat or by passing electric current directly through it.

A boom can be made to bend or fold to ensure that the field of view of mirror assembly 40a is not obscured by satellite 50 body. The bend can be accomplished with a mechanical joint, or the boom can be caused to bend by incorporating a shape memory section into it. With this boom construction, pivot drive 75 will not be required.

Mirror Surface Material Variants

Since mirror 40 operates in high vacuum and low temperature (when not in direct sunlight) of space, numerous materials are feasible for mirror constriction, such as metals and alloys, including low melting temperature ones such as gallium (Ga), cesium (Cs), rubidium (Rb), indium (In), mercury (Hg), tin-based solders and lightweight metals: lithium (Li), sodium (Na), potassium (K), calcium (Ca), aluminum (Al) and their alloys. A very good reflectance performance is achieved by aluminum, silver and gold. Also, for example, very high broadband light reflectivities, from deep ultra-violet to visible light wavelengths can be achieved by using metallic potassium, especially at low temperatures of space. The cooling regime for some metals or alloys may have to be adjusted to create an amorphous, glass-like, rather than crystalline, composition and ensure smooth reflecting surface.

Precursor Container Variants

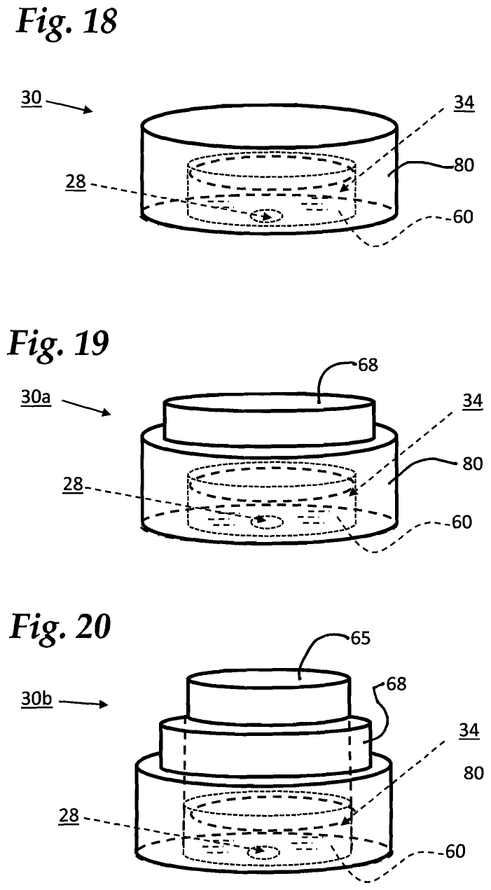

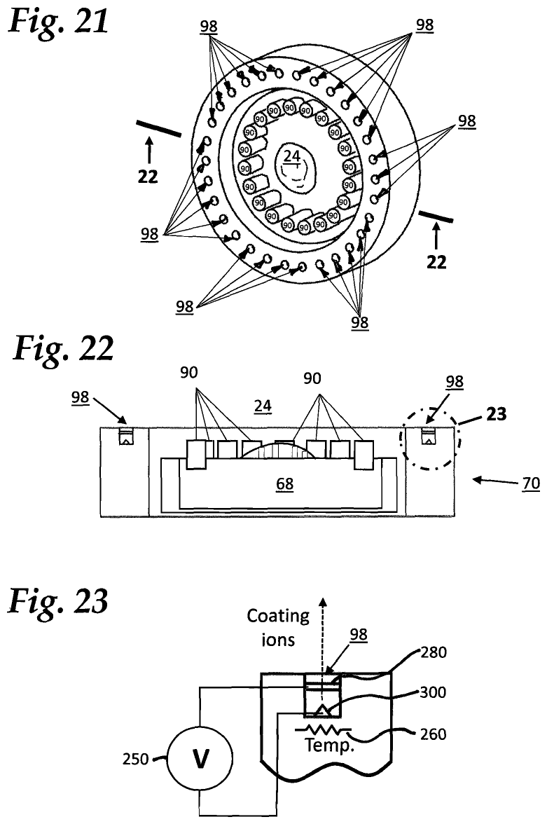

Several variants of container system 30 for the mirror precursor material 60 are presented on FIGS. 18 through 20. Container 30 comprises a case 80 with internal cavity 34 containing liquid precursor material 60. Orifice 28 permits the outflow of material 60 onto deployed mirror support 40a.

Container variant 30a in addition comprises heater 68 to melt material 60. This container can be used with material 60 which would be solid or viscous during launch.

Container variant 30b additionally comprises piston 65 to expel material 60. Piston 65 can be actuated with a pre-compressed spring, a shape-memory type actuator, electrical motor driving a screw-type actuator assembly or an eccentric, compressed gas, or with a pyrotechnic gas generator.

It should be noted that the features of different container variants can be combined, for example, a piston 65 of container 30c can be used with container 30.

Shape Memory Components Heat Pipe Implementations

Struts 160, corrugated boom 150, actuators 170 and 180 and, as previously mentioned, support 40, can all be executed as heat pipes rather than solid parts. For example, strut 160 shown in cross section on FIG. 9 can be made tubular or hollow with internal lumen 19b containing wick 19a for transport of vapor and liquid phases of heat pipe working fluid, respectively. Actuators 170 and 180 can be of similar construction. Utilizing heat pipe technology can facilitate fast heating and deployment of shape-memory components since their heating does not rely on a relatively slow heat diffusion phenomenon.

Strut Variants

Additionally, struts 160 can be formed to transform from cylindrical cross section into a ‘T’—(160a), an ‘I’—(160b) or a ‘Y’—(160c) cross sections upon deployment, as shown on FIG. 11.

Similarly, as shown on FIGS. 12 and 13 struts 160 can have hollow non-cylindrical cross sections 27 and 29 with corresponding lumens 27b and 29b, which expand into tubular cross sections 27a and 29a with corresponding lumens 27a and 29b, respectively, upon application of heat. Struts of these cross sections would have different mechanical characteristics, such as stiffness, weight, or be particularly suitable for routing signal cables to image/cure/coat assembly 70.

Additional System Features

Electrical contacts 15 used for direct heating of shape memory components by electric current can be made to disengage from the heated components upon deployment. They can also be made frangible, to also disengage from the components upon their deployment.

Although not shown, satellite 50 contains articulation means, such as reaction wheels or a propulsion system. Also not shown, solar panels, fixed or deployable, which if present, are preferably deployed after the mirror is created, to simplify satellite control during the mirror creation process.

Although not shown, satellite 50 may also contain wireless communication means for receiving commands and transmitting acquired images.

In addition, although not shown, satellite 50 includes various electronics control-, power- and cooling systems necessary for its operation.

While a direct mirror-to-imaging system 24 is disclosed in instant Application, a secondary imaging system can be added as well. Such secondary optical system may comprise a spherical or toroidal convex mirror or a combination of a flat mirror and an imaging lens system. Such systems are well known in their respective art.

Additionally, imaging system 24 can have a shutter to protect it from direct sunlight exposure collected by the mirror.

Mirror pivot drive 75 can be implemented as an electro-mechanical drive or as a shape-memory bending element actuated by heat.

Precursor material 60 may have additives or fillers to affect its flowing/filling properties in liquid state, melting or softening temperature, reflectance and/or dimensional stability after solidification. For example, nanosilica additives increase photopolymers post-cure dimensional stability.

Since sun's radiation emission spectrum peaks in the violet, UV-curable precursor photopolymers can be exposed to sunlight for curing, either as a backup to the UV LED sources, or the precursor primary curing mechanism.

Mirror support 40 may be made reflective on its one or both surfaces to minimize heating by sunlight and minimizing heat-induced stress in the formed mirror. Alternatively, it can have a thermally absorbent coating on its obverse surface, to facilitate melting of solid precursors by the sun.

Dispensing of liquid precursor photopolymers may proceed in several successive stages, to enable curing of a single layer at a time.

Composition of the deposited precursor layers can be made to vary by pre-filling precursors in the precursor container in a particular sequence or by employing several precursor material dispensers.

While described coating process uses vaporized material deposition, other ways of depositing reflective and protective coatings can be used for the mirror. For example, there exists a well-known liquid-based deposition of silver using a so-called ‘silvering’ process. Additionally, other chemical metals deposition techniques exist, such as ‘electro-less’ nickel, tin and copper deposition processes.

Stand-Alone Mirror Structures

Stand-alone mirror structures can be made by substituting a satellite 50 and boom 120 with a counterweight connected to a mirror support by a strut and following the mirror-generating procedures described above. Such structures can be filled on-orbit with precursor materials and spun by external mechanisms or human operators to generate paraboloid mirror surfaces.

Even though the foregoing descriptions concern small, miniature and ‘nano’ satellites, the methods, components and structures described can be readily utilized for conventional and even large and extremely large satellites.

Although descriptions provided above contain many specific details, they should not be construed as limiting the scope of the present invention.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings can be replaced by alternative features serving the same, equivalent, or similar purpose, unless expressly stated otherwise.

Thus, the scope of this invention should be determined from the appended claims and their legal equivalents.

I claim:

1. A satellite comprising a body, a mirror support and a paraboloid mirror, said mirror formed in space by spinning said satellite around at least two orthogonal axes.

2. The satellite of claim 1 wherein said mirror is generated from a precursor material selected from the group consisting of:
a) photopolymers,
b) thermoplastic polymers,
c) thermoset polymers,
d) metals and alloys.

3. The satellite of claim 2 wherein said precursor material is dispensed in a liquid form, subsequently assumes a paraboloid form due to said spinning of said satellite, and subsequently solidified.

4. The satellite of claim 3 wherein said precursor material is solidified by cooling.

5. The satellite of claim 3 wherein said precursor material is solidified by exposure to radiation.

6. The satellite of claim 1 wherein said mirror further comprises at least one optical coating on its surface, said coating deposited onto said mirror after said mirror has been formed.

7. A satellite comprising a body, an extendable boom having a proximal end and a distal end, said boom transformable from its stowed configuration into its extended configuration, said boom connected by said proximal end to said satellite body, said boom at said distal end connected to a mirror pivot mechanism, said pivot mechanism connected to a deployable mirror support, said mirror support transformable from its stowed configuration into its deployed configuration, said mirror support in said deployed configuration assuming a disc shape, said disk further comprising a perpendicular wall along its periphery, said mirror support further comprising mirror precursor container, said precursor container located at the center of said disk, a mirror precursor material stored in said precursor container, said container communicating via an aperture with said mirror support when said support is in said deployed configuration, said precursor transferable into said support via said aperture, said satellite being capable of spinning simultaneously around a first axis perpendicular to the surface of said disk and passing through the center of said disk, and a second axis perpendicular to said first axis, said second axis passing through the center of mass of a combination of: a) said satellite, b) said boom in said deployed configuration and c) said mirror support in said deployed configuration, a paraboloid surface formed on said precursor material as a result of said satellite spinning, said precursor solidified after forming said paraboloid surface.

8. The satellite of claim 7 wherein said boom comprises at least two co-axial tubular telescopic elements, said elements comprising at least one innermost telescopic element and at least one outermost telescopic element, said elements nested inside each other in stowed configuration, said elements by action of a boom actuator extending to form an elongated tubular assembly in said deployed configuration of said boom.

9. The satellite of claim 8 wherein said boom actuator comprises a helical coil, said coil made of shape memory material, said coil positioned co-axially with said telescopic elements and connected on its proximal end to a proximal end of said outermost telescopic element and on its distal end to a distal end of said innermost telescopic element, said coil prior to deployment comprising a compressed shape, said coil extending lengthwise by being heated to near or above glass transition temperature of said shape memory material and urging said telescopic elements into said deployed configuration of said boom.

10. The satellite of claim 8 wherein said boom actuator comprises at least one elongated rod, said rod made of shape memory material, said rod folded or coiled in stowed configuration, said rod comprising a proximal end and a distal end, said rod on its said proximal end connected to a proximal end of said outermost telescopic element, said rod on its said distal end connected to a distal end of said innermost telescopic element, said rod straightening from said stowed configuration upon being heated to near or above glass transition temperature of said shape memory material and extending said telescopic feed by pushing said distal end of said innermost element away from said proximal end of said outermost element.

11. The satellite of claim 7 wherein said boom comprises a hollow cylinder, said boom having a first stowed configuration and a second deployed configuration, said stowed configuration comprising a pleated cylindrical shell, wherein pleats of said shell are oriented perpendicular to the longitudinal axis of said shell, said deployed configuration comprising a smooth cylinder, said boom in said deployed configuration having length greater that said boom in said stowed configuration, said boom made of shape memory material, said boom upon being heated to a temperature near or above its material glass transition temperature transforming from its said stowed configuration to its said deployed configuration.

12. The satellite of claim 7 wherein said boom comprises a hollow cylinder, said boom having a first stowed configuration and a second deployed configuration, said stowed configuration comprising said hollow cylinder helically coiled, said deployed configuration comprising said hollow cylinder straightened, said boom made of shape memory material, said boom upon being heated to a temperature near or above its material glass transition temperature transforming from its said stowed configuration to its said deployed configuration.

13. The satellite of claim 7 wherein said precursor material is selected from the group consisting of:
e) photopolymers,
f) thermoplastic polymers,
g) thermoset polymers,
h) metals and alloys.

14. The satellite of claim 7 further comprising at least one radiation source, said radiation source emitting radiation capable of solidifying said precursor upon exposure.

15. The satellite of claim 7 further comprising a material deposition system, said system capable of depositing material or materials onto said paraboloid surface.

16. The satellite of claim 7 further comprising a reflective coating on said paraboloid surface.

17. The coating of claim 16 comprising at least one metallic layer

18. The coating of claim 16 comprising at least one dielectric layer

19. The coating of claim 16 comprising at least one metallic and at least one dielectric layer.

20. A method of creating a paraboloid mirror system while in space, said system comprising a mirror support and a counterweight, said support and said counterweight being interconnected, and generating a paraboloid mirror surface on said mirror support by the steps of:
a) spinning said mirror system in two orthogonal axes, namely, a first axis parallel to the centerline of said support and passing through the center of said support and a second axis perpendicular to said axis, said second axis intersecting said first axis at center of mass of combined said mirror support and said counterweight,
b) dispensing liquid precursor material into said mirror support,
c) allowing said precursor to attain a paraboloid surface resulting from spinning of said support and said precursor around said first and said second axes,
d) allowing or causing said precursor to solidify with said paraboloid surface.

21. A method of claim 20, further comprising mirror surface coating operation, said operation depositing optical coating or coatings onto said paraboloid mirror surface.

22. A method of producing paraboloid mirrors in space comprising the steps of:
a. providing mirror support structure, said support structure comprising substantially a circular disk, said disk comprising two surfaces, namely, a top surface and a bottom surface, said disk further comprising a circular wall, said wall perpendicular to said top surface, said wall located along a periphery of said disk, said wall located on said top surface and in communication therewith,
b. spinning said support structure around a first axis, said first axis perpendicular to said top surface of said disk and disposed through a center of mass of said disk,
c. simultaneously spinning said support structure around a second axis, said second axis orthogonal to said first axis, wherein center of rotation around said second axis is disposed at a distance from said top surface of said disk,
d. placing a mirror precursor material in liquid state onto said top surface of said disk,
e. allowing said precursor material to assume a paraboloid shape as a result of said structure spinning around said first and said second axes,
f. allowing or causing said precursor material to solidify in said paraboloid shape.

23. The method of claim 21, whereby said liquid precursor material is selected from the group consisting of:
a) photopolymers and mixtures thereof,
b) photopolymers containing thermal expansion coefficient-reducing additives,
c) cycloaliphatic epoxies and mixtures thereof,
d) cyanoacrylates and mixtures thereof
e) styrenic compounds,
f) vinyl ethers,
g) N-vinyl carbazoles,
h) lactones,
i) lactams,
j) cyclic ethers,
k) cyclic acetals,
l) cyclic siloxanes,
m) phthalic diglycol diacrylates,
n) thermoplastic polymers,
o) thermoset polymers,
p) metals and alloys.

24. The method of claim 21, whereby said precursor material is solidified by exposure to radiation.
